(19) United States
(12) Patent Application Publication
(10) Pub. No.: US 2009/0256365 A1
(43) Pub. Date: Oct. 15, 2009

(54) Circuit insulation methods and systems for vehicle door latches

(75) Inventors: Nigel V. Spurr, Shirley (GB); Michael J. Shelley, Fauldhouse (GB); Richard T. Hayes, Motherwell (GB); William F. Eaton, Pearl City, IL (US); Hugh D. Gibson, Edinburgh (GB); Alex Crawford, East Kilbride (GB); Ajaykumar Vaidhyanathan, Mylapore (IN); Scott A. Vorwald, Lena, IL (US); Kenneth V. Bechtold, Freeport, IL (US); Curtis B. Johnson, Freeport, IL (US); Duncan S. Murchie, Crieff (GB); Daniel D. Kilker, University Park, FL (US); Abanni B. Maxwell, Rockford, IL (US); Patrick H. Shannon, Eskbank (GB); Gillian J. Madden, Bothwell (GB); Adrian T. Kettle, Shrivenham (GB)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/082,538

(22) Filed: Apr. 11, 2008

(51) Int. Cl. B65D 53/06; E05B 47/02

(52) U.S. Cl. 292/307 B; 70/277

(57) ABSTRACT

An injection molding method and system for an electrical circuit utilized in vehicle door latch mechanisms is disclosed herein. A mold is generally provided in which a mold cavity is formed therein from walls of the mold. An electrical circuit associated with vehicle door latch and/or integrated with the vehicle door latch can be located within the mold cavity. A plastics material can then be injection molded into the mold cavity of the mold, wherein the plastics material covers and seals the electrical circuit to provide insulation and environmental protection to the electrical circuit.

### CROSS REFERENCE TO RELATED APPLICATIONS

This patent application claims the priority and benefit of U.S. patent application Ser. No. 10/727,242 filed Dec. 3, 2003 entitled “CIRCUIT INSULATION METHODS AND SYSTEMS FOR VEHICLE DOOR LATCHES” which is herein incorporated by reference.

### TECHNICAL FIELD

Embodiments are generally related to door latch assemblies, including door latching mechanisms utilized in automobiles and other vehicles. Embodiments are also related to injection molding devices and techniques.

### BACKGROUND OF THE INVENTION

Latching mechanisms are utilized in a variety of commercial and industrial applications, such as automobiles, airplanes, trucks, and the like. For example, an automotive closure, such as a door for an automobile passenger compartment, is typically hinged to swing between open and closed positions and conventionally includes a door latch that is housed between inner and outer panels of the door. The door latch functions in a well-known manner to latch the door when it is closed and to lock the door in the closed position or to unlock and unlatch the door so that the door can be opened manually.

The door latch can be operated remotely from inside the passenger compartment by two distinct operators—a sill button or electric switch that controls the locking function and a handle that controls the latching function. The door latch is also operated remotely from the exterior of the automobile by a handle or push button that controls the latching function. A second distinct exterior operator, such as a key lock cylinder, may also be provided to control the locking function, particularly in the case of a front vehicle door. Each operator is accessible outside the door structure and extends into the door structure where it is operatively connected to the door latch mechanism by a cable actuator assembly or linkage system located inside the door structure.

Vehicles, such as passenger cars, are therefore commonly equipped with individual door latch assemblies which secure respective passenger and driver side doors to the vehicle. Each door latch assembly is typically provided with manual release mechanisms or lever for unlatching the door latch from the inside and outside of the vehicle, e.g. respective inner and outer door handles. In addition, many vehicles also include an electrically controlled actuator for remotely locking and unlocking the door latches.

One of the problems inherent with conventional latching mechanisms is that it is difficult, but necessary, to seal electrical circuits utilized with latching mechanisms and assemblies, while reducing the number of components needed and simplifying the circuitry thereof. Typically, an electrical circuit requiring environmental protection is assembled to an enclosure, which is either sealed by the addition of seal components or plastic material is poured into the enclosure to cover and insulate the circuit. Such a process is complex and time consuming, and often, does not fully protect the circuitry associated with the latching mechanism, such as a vehicle door latch. A need therefore exists to simplify the circuitry enclosure process, while still maintaining the integrity of both the circuitry and the associated latching mechanism.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for an improved latch mechanism.

It is another aspect of the present invention to provide for improved latching methods and systems for use in automobiles and other vehicles.

It is yet a further aspect of the present invention to provide for improved electrical circuitry associated with latch mechanisms

It is still another aspect of the present invention to provide for improved circuit insulation for vehicle door latches.

The aforementioned aspects of the invention and other objectives and advantages can now be achieved as described herein. An injection molding method and system for an electrical circuit utilized in vehicle door latch mechanisms is disclosed herein. A mold is generally provided in which a mold cavity is formed therein from walls of the mold. An electrical circuit associated with vehicle door latch and/or integrated with the vehicle door latch can be located within the mold cavity. A plastics material can then be injection molded into the mold cavity of the mold, wherein the plastics material covers and seals the electrical circuit to provide insulation and environmental protection to the electrical circuit. The electrical circuit is thus integrated with the latch mechanism, wherein the electrical circuit communicates electrically with the latch mechanism. The mold itself can be configured to provide a mold form geometry that permits a plurality of components to be connected electrical to the electrical circuit and the latch mechanism after the injection molding of the plastics material into the mold cavity.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a vehicle door mounted to a passenger vehicle in which a preferred embodiment of the present invention can be implemented;

FIG. 2 illustrates a first step of an injection molding method, which can be implemented in accordance with a preferred embodiment of the present invention;

FIG. 3 illustrates a second step of an injection molding method, which can be implemented in accordance with a preferred embodiment of the present invention;

FIG. 4 illustrates a third step of an injection molding method, which can be implemented in accordance with a preferred embodiment of the present invention;

FIG. 5 illustrates a fourth step of an injection molding method, which can be implemented in accordance with a preferred embodiment of the present invention; and

FIG. 6 illustrates an injection molding system, which can be adapted for use in accordance with an embodiment of the present invention. It can be appreciated that system 600 is not considered a limiting feature of the present invention, but is described herein for general edification and purposes only.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

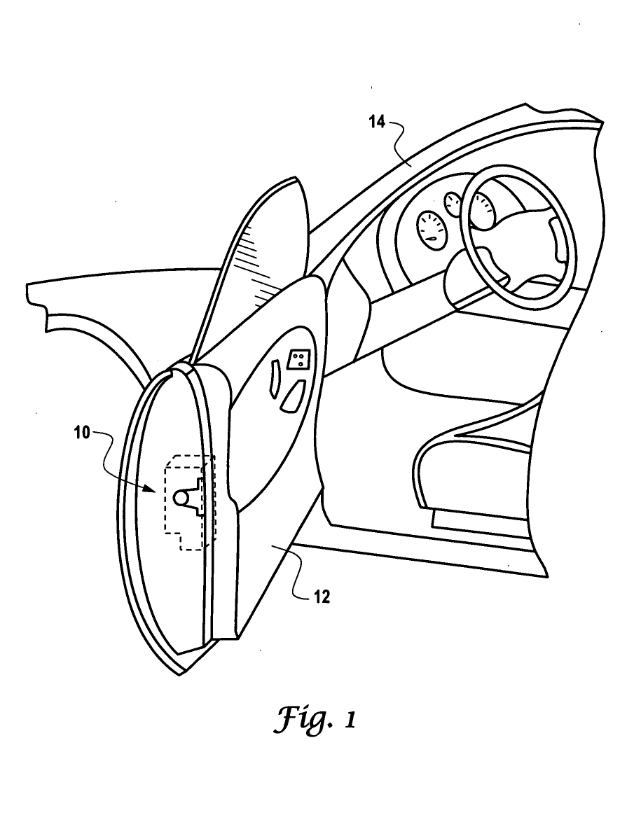

FIG. 1 illustrates a perspective view of a vehicle door 12 mounted to a passenger vehicle in which a preferred embodiment of the present invention can be implemented. A vehicle, such as an automobile can be equipped with one or more individual door latch assemblies 10, which secure respective passenger and driver side doors to the vehicle 14. Each door latch assembly 10 is typically provided with manual release mechanisms or lever for unlatching the door latch from the inside and outside of the vehicle, e.g. respective inner and outer door handles. In addition, many vehicles can also be equipped with electrically controlled actuators for remotely locking and unlocking the door latches. As indicated in FIG. 1, a door latch assembly 10 can be mounted to a driver's side vehicle door 12 of a passenger vehicle 14. The door latch assembly 10 may be mounted to front and rear passenger side doors thereof and may be incorporated into a sliding side door, rear door, a rear hatch or a lift gate thereof, depending upon design constraints.

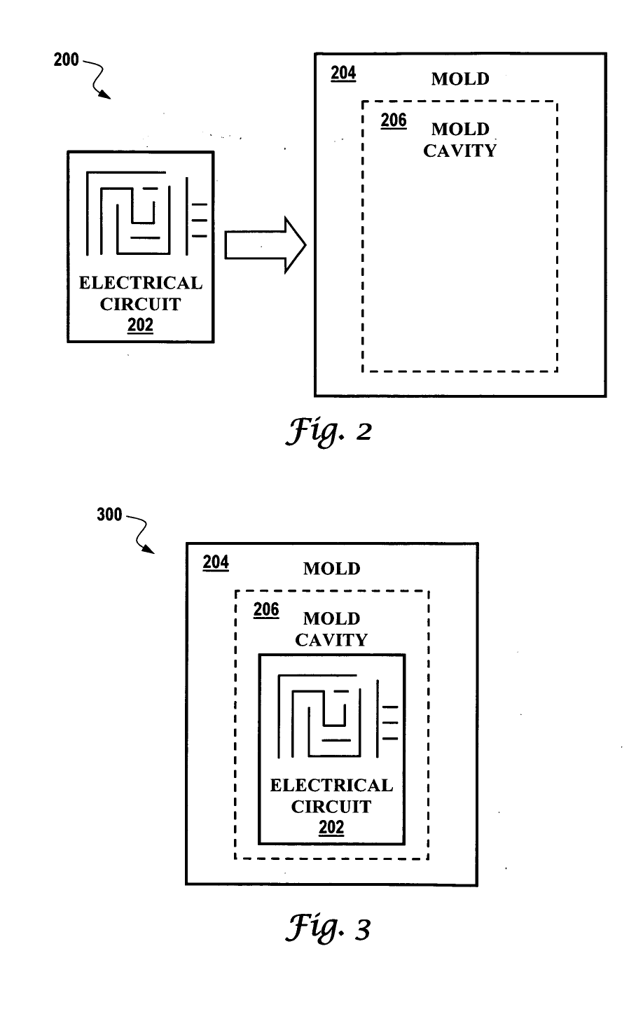

FIG. 2 illustrates a first step 100 of an injection molding method, which can be implemented in accordance with a preferred embodiment of the present invention. In typical electrical circuit and associated latch assembly implementations, an electrical circuit requiring environmental protection is assembled to an enclosure, which is either sealed by the addition of extra seal components and other parts or a plastics material is poured into an enclosure to cover and insulate the circuit. The process steps 100 to 400 depicted in FIGS. 2-5 herein dispenses with the enclosure as an element in the circuitry protection process. As depicted in FIG. 2, an electrical circuit 202 can be prepared for insertion into a mold cavity 206 of a mold 204. Note that in FIGS. 2-5 herein, identical or similar parts or elements are indicated by identical reference numerals.

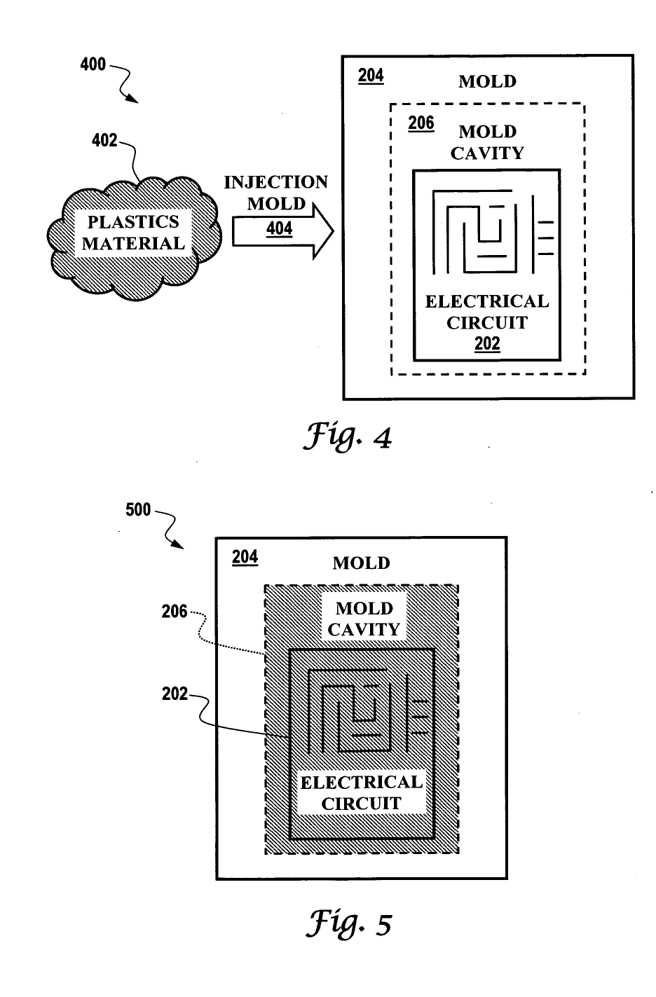

FIG. 3 illustrates a second step 200 of an injection molding method, which can be implemented in accordance with a preferred embodiment of the present invention. As indicated in FIG. 3, electrical circuit 202 can be placed into mold cavity 206. FIG. 4 illustrates a third step 300 of an injection molding method, which can be implemented in accordance with a preferred embodiment of the present invention. As indicated in FIG. 4, after the electrical circuit 206 is placed into mold cavity 206, a plastics material 402 can be injection molded, as illustrated by arrow 404, into mold cavity 206, effectively covering electrical circuit 206 and filling mold cavity 206.

FIG. 5 illustrates a fourth step 400 of an injection molding method, which can be implemented in accordance with a preferred embodiment of the present invention. As indicated in FIG. 5, mold cavity 206 is now filled with plastics material 402, which was shown in FIG. 4. Note that the mold form can be configured to include a geometry that permits plastics material 402 to possess additional features, such as locations, mounting surfaces, pivots, flanges, and components thereof which mate and seal with other components of the latching mechanism in which electrical circuit 202 is located. Electrical circuit 202 can be integrated, for example, with door latch assembly 10 of FIG. 1.

One of the intents of the embodiments depicted in FIGS. 1-5 is protect a circuit board that contains electrical/electronic components sensitive to the effects of water ingress. In essence, the insert in any molding thereof is an electronic circuit that includes a circuit board in which electronic components thereof are assembled to the circuit board prior to any molding processes. Usually, in conventional mechanical latches, such as the latch assembly 10 of FIG. 1, an insert is a stamping that, after over-molding, has components added to it. In the embodiments of FIGS. 1-5, however, the components are assembled to the circuit board prior to the molding process. Electrical circuit 202 generally comprises an electrical circuit which can be located within the mold cavity 206. The electrical circuit 202, however, comprises electrical components assembled to an electrical circuit board prior to the actual injection molding operation described herein.

It can be appreciated that embodiments may be implemented utilizing injection molding techniques. A variety of injection molding devices are known in the art. Reference is made herein to one type of an injection molding device in order to provide the reader with a general view of the context in which one possible embodiment of the present invention can be implemented. In general, injection molding devices can include a servo-motor for driving rotation of a screw rotates the screw whereby resin falling on a rear portion of the screw from a hopper is melted and a given amount thereof can be fed to a tip end of a heating cylinder. At this time, the screw retreats while being subjected to pressure of molten resin accumulating at the tip end of the heating cylinder.

A drive shaft can be connected directly to the rear end of the screw. The drive shaft can be rotatably supported on a pressure plate through bearings. The drive shaft is driven through a timing belt by a servo-motor for driving rotation of the screw. The pressure plate can be driven through a ball screw by a servo-motor for injection to advance and retreat along guide bars. The foregoing pressure of molten resin is detected by a load cell in a manner described later. A detected value of the load cell can be fed back by a feed-back control loop for pressures.

Thereafter, driving of the servo-motor for injection causes the pressure plate to advance to fill molten plastic resin into a mold with the screw tip end as a piston. At the end of the filling process, the molten resin fills a cavity of the mold. At that time, the advancing motion of the screw causes conversion of velocity control into pressure control. Such conversion of velocity control into pressure control is referred to as a V-P conversion. Thereafter, the resin in the cavity of the mold becomes cold under a set pressure. Resin pressure is controlled in feed-back control loop like the above-mentioned pressure control.

In the injection device, when the process is terminated, the device shifts to a succeeding molding cycle. Meanwhile, in a mold clamping device, the mold can be opened to permit an ejector mechanism to discharge a molding product having been cooled and solidified, and then the mold is closed to shift to the process.

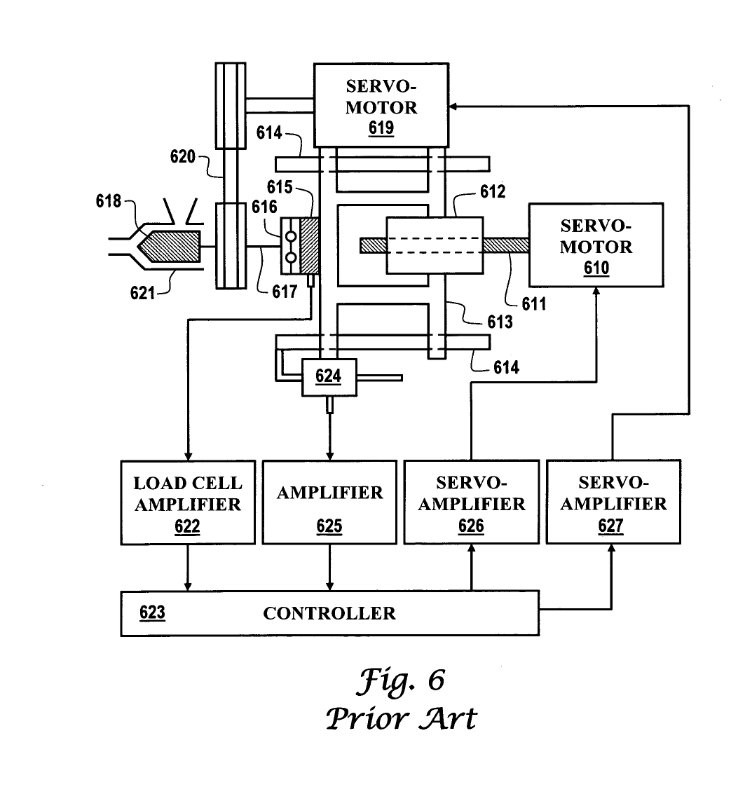

FIG. 6 illustrates an injection molding system 600, which can be adapted for use in accordance with an embodiment of the present invention. It can be appreciated that system 600 is not considered a limiting feature of the present invention, but is described herein for general edification and purposes only. System 600 represents merely one of many potential types injection molding devices that can be adapted for use with an embodiment of the present invention.

System 600 can be implemented as an injection molding device that performs filling of a molten plastic resin by converting rotating motion of a servo-motor into linear motion with the use of a ball screw and a nut. In system 600, rotation of a servo-motor 610 for injection can be transmitted to a ball screw 611. A nut 612 adapted to advance and retreat upon rotation of the ball screw 611 can be fixed to a pressure plate 613. The pressure plate 613 can be movable along a plurality of guide bars 614 (i.e., only two being shown) fixed to a base frame (i.e., not shown). Advancing and retreating movements are transmitted to a screw 618 through a load cell 615, a bearing 616, and a drive shaft 617. The drive shaft 617 can be also rotatingly driven through a timing belt 620 by a servo-motor 619 for driving rotation of the screw.

Rotating driving of the servo-motor 619 causes the screw 618 to retreat in a heating cylinder 621 while rotating whereby molten resin can be accumulated at the tip end of the heating cylinder 621. And rotating driving of the servo-motor 610 causes advancement of the screw 618 to thereby fill the mold with the accumulated, molten resin and pressurize the resin for molding. At this time, forces, which push the resin, are detected as reaction forces by the load cell 15.

A detected value from the load cell 615 can be amplified by a load cell amplifier 622 to be input into a controller 623. Mounted on the pressure plate 613 is generally a position detector 624 for detection of amounts of movements of the screw 618. A detected value from the position detector 624 can be amplified by an amplifier 625 to be input into the controller 623. In accordance with setting established by an operator, the controller 23 outputs to servo-amplifiers 626, 627 current (torque) commands depending upon the respective processes. The servo-amplifiers 626, 627 control drive currents of the servo-motors 610, 619 to control output torque of the motors.

A non-limiting example of an injection molding system and method, which can be adapted for use in accordance with one embodiment of the present invention is disclosed in U.S. Pat. No. 6,287,4881, “Method for Injection Molding of High Quality Parts,” which issued to Dougherty on Sep. 11, 2001. Another non-limiting example of an injection molding method and system, which can be adapted for use in accordance with another embodiment of the present invention is disclosed in U.S. Pat. No. 6,562,261, “Injection Molding Method and Control System for Injection Molding Machines,” which issued to Onishi on May 13, 2003. U.S. Pat. Nos. 6,287,4881 and 6,562,261 are incorporated herein by reference. Although U.S. Pat. Nos. 6,287,4881 and 6,562,261 are referenced herein, such information does not constitute limiting features of the present invention, but are instead referred to herein for general illustrative and edification purposes only.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are herein as follows. Having thus described the invention what is claimed is:

1. A system comprising:
a latch component comprising plastic and an electrical circuit;
wherein the electrical circuit comprises electrical components assembled to an electrical circuit board;
wherein the plastic encapsulates the electrical circuit whilst permitting a plurality of components to be connected electrically to the electrical circuit.

2. The method of claim 1 wherein the latch component comprises at least one plastic mounting surface feature.

3. The method of claim 1 wherein the latch component comprises at least one plastic pivot feature.

4. The method of claim 1 wherein the latch component comprises at least one plastic flange feature.

5. The method of claim 1 wherein the latch component comprises at least one plastic seal feature.

6. The method of claim 1 wherein the latch component comprises at least one plastic mating feature.

7. A system comprising:
a latch component comprising plastic and an electrical circuit;
wherein the electrical circuit comprises electrical components assembled to an electrical circuit board;
wherein the plastic encapsulates the electrical circuit whilst permitting a plurality of components to be connected electrically to the electrical circuit; and
wherein the latch component is integrated within a latch mechanism and wherein the electrical circuit communicates electrically with said latch mechanism.

8. The method of claim 7 wherein the latch component comprises at least one plastic mounting surface feature.

9. The method of claim 7 wherein the latch component comprises at least one plastic pivot feature.

10. The method of claim 7 wherein the latch component comprises at least one plastic flange feature.

11. The method of claim 7 wherein the latch component comprises at least one plastic seal feature.

12. The method of claim 7 wherein the latch component comprises at least one plastic mating feature.

13. The method of claim 7:
wherein the latch component comprises at least one plastic mounting surface feature;
wherein the latch component comprises at least one plastic pivot feature;
wherein the latch component comprises at least one plastic flange feature;
wherein the latch component comprises at least one plastic seal feature; and
wherein the latch component comprises at least one plastic mating feature.

14. A system comprising:
a latch component comprising plastic and an electrical circuit;
wherein the electrical circuit comprises electrical components assembled to an electrical circuit board;
wherein the plastic encapsulates the electrical circuit whilst permitting a plurality of components to be connected electrically to the electrical circuit.
wherein the latch component is integrated within a latch mechanism and wherein the electrical circuit communicates electrically with said latch mechanism; and
wherein said latch mechanism comprises a vehicle door latch of a vehicle door latch assembly.

15. The method of claim 14 wherein the latch component comprises at least one plastic mounting surface feature.

16. The method of claim 14 wherein the latch component comprises at least one plastic pivot feature.

17. The method of claim 14 wherein the latch component comprises at least one plastic flange feature.

18. The method of claim 14 wherein the latch component comprises at least one plastic seal feature.

19. The method of claim 14 wherein the latch component comprises at least one plastic mating feature.

20. The method of claim 14:
wherein the latch component comprises at least one plastic mounting surface feature;
wherein the latch component comprises at least one plastic pivot feature;
wherein the latch component comprises at least one plastic flange feature;
wherein the latch component comprises at least one plastic seal feature; and
wherein the latch component comprises at least one plastic mating feature.
